(19) United States
(12) Patent Application Publication
(10) Pub. No.: US 2013/0013368 A1
(43) Pub. Date: Jan. 10, 2013

(54) Processor Implemented Systems and Methods for Winter Tire Pre-Ordering and Tire Storage

(76) Inventor: James H. Grant, JR., Hudson, OH (US)

(21) Appl. No.: 13/597,379

(22) Filed: Aug. 29, 2012

Related U.S. Application Data
(63) Continuation of application No. PCT/US2011/027135, filed on Mar. 4, 2011.
(60) Provisional application No. 61/311,041, filed on Mar. 5, 2010.

(51) Int. Cl. G06Q 10/06

(52) U.S. Cl. 705/7.25; 705/7.12

(57) ABSTRACT

Systems and methods for preordering winter tires through a preordering system are described. Information related to winter tires available for preordering is received at the preordering system from a tire provider and is provided to a dealer. Information of preorders of winter tires is received from a dealer and provided to the tire provider. Updates on the status of the preorders of winter tires are received from the tire provider and transmitted to the dealer.

### CROSS-REFERENCE TO RELATED APPLICATIONS

This application is a continuation of PCT Application No. PCT/US2011/027135, filed on Mar. 4, 2011, entitled “Processor Implemented Systems and Methods for Winter Tire Pre-Ordering and Tire Storage,” which claims priority to and the benefit of U.S. Provisional Application No. 61/311,041, filed Mar. 5, 2010, entitled “Processor Implemented Systems and Methods for Winter Tire Pre-Ordering and Tire Storage,” the entirety of both of which is incorporated herein by reference.

### TECHNICAL FIELD

This disclosure relates generally to ordering and providing storage services to tires and a computer-implemented system for implementing the method.

### BACKGROUND

Winter tires are designed to provide improved performance under low temperature conditions, compared to tires for summer conditions. Tread compound of winter tires is usually softer than that used in tires for summer conditions, providing better grip on ice and snow, but wearing more quickly at higher temperatures.

### SUMMARY

As discussed herein, processor-implemented systems and methods are provided for preordering winter tires through a preordering system. For example, information related to winter tires available for preordering is received at the preordering system from a tire provider and is provided to a dealer. Information of preorders of winter tires is received from a dealer and provided to the tire provider. Updates on the status of the preorders of winter tires are received from the tire provider and transmitted to the dealer.

Processor-implemented systems and methods are provided for tire storage services. For example, a tire storage services order from a dealer is received at a tire storage service system and is provided to a tire storage service provider. Status updates of tire storage services performed by the tire storage service provider are received at the tire storage service system, and are provided to the dealer. A tire retrieval request from the dealer is received at the tire storage service system, where the tire retrieval request comprises particular tires and a date of delivery. The tire retrieval request is provided to the tire storage service provider for delivery of the particular tires on the date of delivery.

### BRIEF DESCRIPTION OF THE DRAWINGS

FIG. 1 depicts an example embodiment where customers, dealers and tire providers interact with a winter tire pre-ordering system.

FIG. 2 depicts an example embodiment where a dealer and a tire provider interact with a winter tire pre-ordering system.

FIG. 3 depicts an example of determining a number of tires pre-ordered by a dealer based on a number of factors.

FIG. 4 depicts an example flow chart of a dealer's interaction with a winter tire pre-ordering system.

FIGS. 5A and 5B depict an example flow chart of a tire provider's interaction with a winter tire pre-ordering system.

FIG. 6 depicts an example embodiment where customers, dealers and tire storage service providers interact with a tire storage service system.

FIG. 7 depicts an example embodiment where a dealer and a tire storage service provider interact with a tire storage service system.

FIG. 8 depicts an example flow chart of a dealer's interaction with a tire storage service system.

FIG. 9 depicts an example flow chart of a tire storage service provider's interaction with a tire storage service system.

FIG. 10 depicts a computer-implemented environment where users can interact with the winter tire pre-ordering system hosted on one or more servers through a network.

FIG. 11 depicts a stand-alone computer where a winter tire pre-ordering system can be implemented.

FIG. 12A-12C depict examples of pre-order reports.

FIG. 13 depicts an example of a web screen for a tire storage services program for dealers to participate.

### DETAILED DESCRIPTION

A winter tire pre-ordering system is discussed herein to provide dealers additional winter tire functionality, automation, and visibility of their pre-orders. Pre-orders of winter tires may be fulfilled later in the year (e.g., October to December) to cover demand for these tires in the winter months. The winter tire pre-ordering system may be utilized to integrate and automate winter tire pre-ordering capability of a tire management website and business process, as well as enhancing ordering and fulfillment processes to meet the winter tire pre-ordering needs. The winter tire pre-ordering system may facilitate and improve interactions of customers, dealers and tire providers.

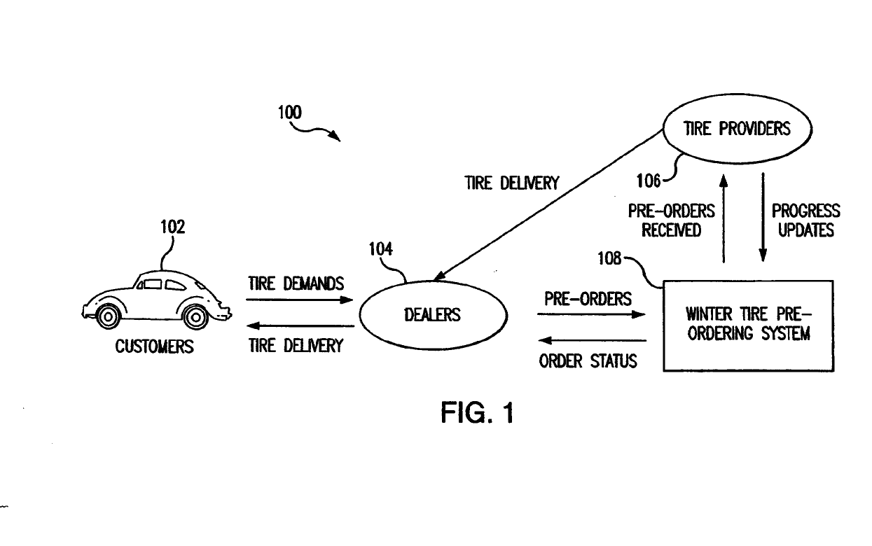

FIG. 1 depicts at 100 an example embodiment where customers 102, dealers 104 and tire providers 106 interact with a winter tire pre-ordering system 108. The dealers 104 may access the winter tire pre-ordering system 108 to submit pre-orders for winter tires to be fulfilled later in the year to satisfy winter tire demands of the customers 102. The tire providers 106 may interact with the winter tire pre-ordering system 108 to receive the pre-orders submitted by the dealers 104. If winter tires are available, the tire providers 106 may deliver the winter tires to the dealers, at a proper time or upon the request of the dealers 104, to fulfill the received pre-orders. Progress updates of the status of fulfilling the pre-orders may be provided to the winter tire pre-ordering system 108 for updating the status of the pre-orders which may be tracked by the dealers 104. Once the dealers 104 receive winter tire delivery from the tire providers 106, winter tires may be delivered, at a proper time or upon the request of the customers 102, to satisfy the winter tire demands of the customers 102.

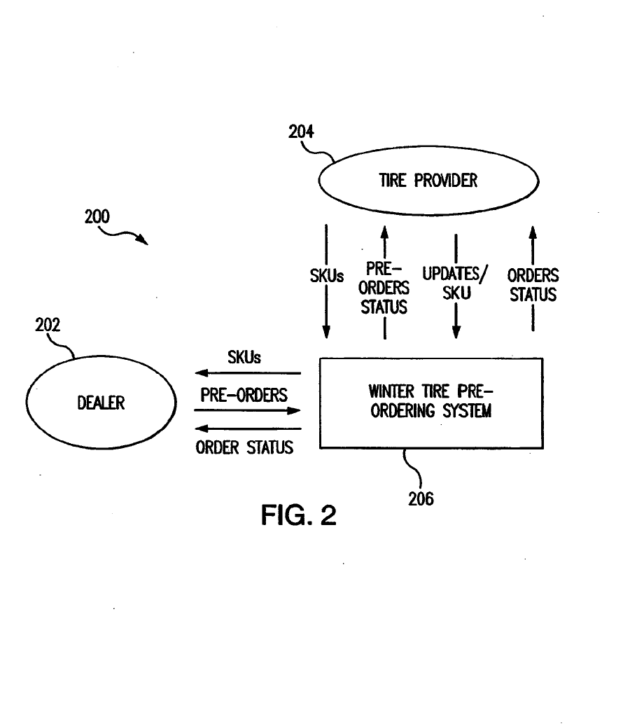

FIG. 2 depicts at 200 an example embodiment where a dealer 202 and a tire provider 204 can interact with a winter tire pre-ordering system 206. Such interaction may be performed remotely via one or more networks or locally. A dealer 202 is an entity who places a pre-order of winter tires and receives delivery of winter tires, e.g., an employee of a dealership, point of sale tire provider, etc. The dealer 202 may access the winter tire pre-ordering system 206 via a web interface to indicate a number of tires that the dealer wishes to procure for an upcoming winter season. The dealer 202 may be provided with a number of stock keeping units (SKUs) of tires that are available for pre-ordering from the winter tire pre-ordering system 206. The dealer 202 provides a listing of quantities for SKUs for which the dealer wishes to pre-order tires to the winter tire pre-ordering system 206. The dealer 202 may then track the status of the fulfillment of the dealer's pre-order via the interface of the winter tire pre-ordering system 206. Once any of the pre-ordered SKUs are shown as available for delivery in the winter tire pre-ordering system, the dealer 202 may request immediate delivery of the pre-ordered SKU quantity.

A tire provider 204 may also interact with the winter tire pre-ordering system 206. The tire provider 204 may be an entity that can distribute tires, such as an employee of a tire distributor, a tire distributor, an employee of a tire manufacturer, or a tire manufacturer. The tire provider 204 may provide, to the winter tire pre-ordering system 206, a listing of SKUs available for pre-ordering along with other data such as pricing for those SKUs that are available for pre-ordering. The tire provider 204 may acquire data, from the winter tire pre-ordering system 206, regarding pre-orders received from the dealer 202. The tire provider 204 may input progress updates on the status of fulfilling of received pre-orders and may also input other data and changes, such as changes to SKUs that are available for pre-order, pricing, as well as other data. The tire provider 204 may also track the status of the fulfillment of received pre-orders through interactions with the winter tire pre-ordering system 206.

The winter tire pre-ordering system 206 may display the pre-orderable SKUs only for the coming open pre-ordering period, and any status values for these SKUs relating to the previous year's pre-orders may be reset, such as quantity requested, quantity allocated, quantity available and quantity shipped values.

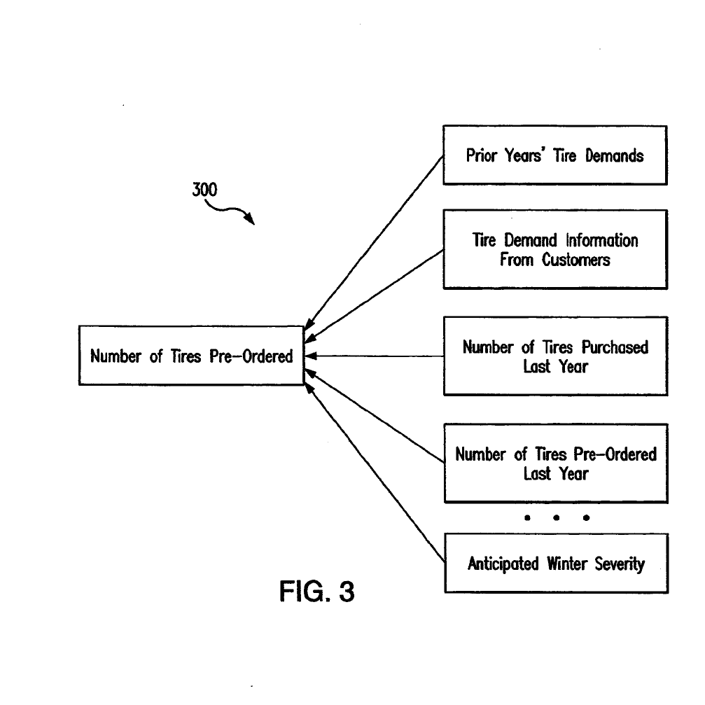

FIG. 3 depicts at 300 an example of determining a number of tires pre-ordered by a dealer based on a number of factors. A dealer may decide to pre-order a number of tires based on a number of factors, such as prior years' tire demands, indication of tire demands from customers of the dealer, the number of tires pre-ordered last year, the number of tires purchased last year, anticipated winter severity, as well as other factors.

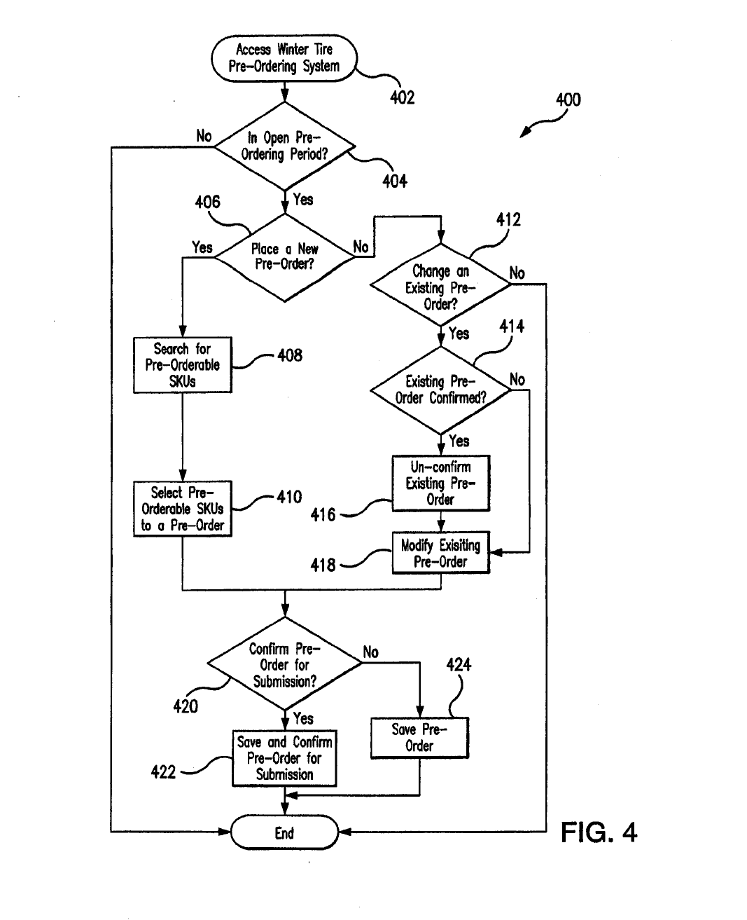

FIG. 4 depicts at 400 an example flow chart of a dealer's interaction with a winter tire pre-ordering system. A dealer may access a winter tire pre-ordering system at 402. Then the dealer may check whether it is in an open pre-ordering period at 404. The beginning and end date of the open pre-ordering period may be set by a tire provider. Whether the dealer can check the open pre-ordering period in the winter tire pre-ordering system may be determined by the tire provider, as well. Leading up to the open pre-ordering period, the dealer may view, in the winter tire pre-ordering system, the winter tire SKUs that may be set to be pre-orderable by the tire provider. Until the open pre-ordering period begins though, the dealer may not be able to add any of these SKUs to a pre-order. A countdown may be displayed in the winter tire pre-ordering system noting the number of days remaining before the open pre-ordering period begins.

During the open pre-ordering period, the dealer may be able to place a new pre-order in the winter pre-ordering system at 406. A countdown may be displayed in the winter tire pre-ordering system noting the number of days remaining in the open pre-ordering period. The dealer may search for pre-orderable SKUs at 408. Among a complete list of the pre-orderable SKUs, the dealer may select a number of SKUs to be added to a pre-order at 410. Wheel Assemblies can be included as pre-orderable SKUs. Alternatively, the dealer may not need to view the complete list of pre-orderable SKUs. Instead, the dealer may search directly for certain pre-orderable SKUs in the winter tire pre-ordering system to be added to a pre-order. The dealer may search for tires by size, SKU, or vehicle. SKUs classified as use-up may have a “Limit Availability” alert wherever selectable.

The dealer may change an existing pre-order during the open pre-ordering period in the winter tire pre-ordering system at 412. The winter tire pre-ordering system may display whether the existing pre-order has been confirmed at 414. If the existing pre-order has been confirmed, it is not editable because all fields in the pre-order are locked. The dealer may need to un-confirm the pre-order at 416 before any modifications may be made to the pre-order. Then the dealer can modify the existing pre-order at 418. An option may be presented to the dealer to confirm the pre-order for submission at 420. The dealer may choose to save and confirm the pre-order for submission at 422, or choose to save the pre-order for later confirmation at 424. A purchase order number that is associated with the pre-order may be required for confirmation.

Following the close of the open pre-ordering period, a dealer's pre-orders are locked down. The winter tire pre-ordering system may display a dealer's pre-orders with embedded status. A dealer may request immediate shipment of pre-ordered SKUs in the dealer's pre-order. The dealer may be limited to requesting shipment on an SKU quantity less than or equal to the available SKU quantity that may be displayed to the dealer. When a pre-ordered SKU quantity is requested to be shipped, the available SKU quantity may be updated in the winter tire pre-ordering system accordingly.

During the open pre-ordering period, the winter tire pre-ordering system may display the status of a pre-order as “confirmed” or “unconfirmed.” The dealer may be alerted if the dealer has an “unconfirmed” pre-order. After the open pre-ordering period ends, the winter tire pre-ordering system may display “unconfirmed” if a pre-order is in the unconfirmed status. If a pre-order is confirmed, the status values of the pre-order are displayed as totals of pre-order lines, such as quantity requested in pre-orders, quantity approved, quantity allocated for pre-orders, quantity available for delivery, and quantity shipped to fulfill pre-orders. A purchase order number associated with a confirmed pre-order may be a dealer's reference point back to the pre-order after the open pre-ordering period. The SKU quantity requested on the confirmed pre-orders at the end of the open pre-ordering period is the SKU quantity that the dealer is committed to purchase and a tire provider committed to deliver. A dealer may be limited to place only one winter tire pre-order. If pre-orders exist outside of the winter tire pre-ordering system, they may be accounted for in buy/sell conversions.

Prices of pre-orderable SKUs may be held constant during the open pre-ordering period. The only exception would be changes due to a price correction. In these correction cases, all dealers with requested pre-order quantity of the corrected SKU may be notified of the corrected price and the corrected price may be the invoice price for the SKU. After the open pre-ordering period, prices of pre-ordered SKUs may change and all affected dealers may be notified of such changes. The new price may be displayed with the SKU in the winter tire pre-ordering system, and the new price may be the invoice price, while the old price may be stored for historical purposes.

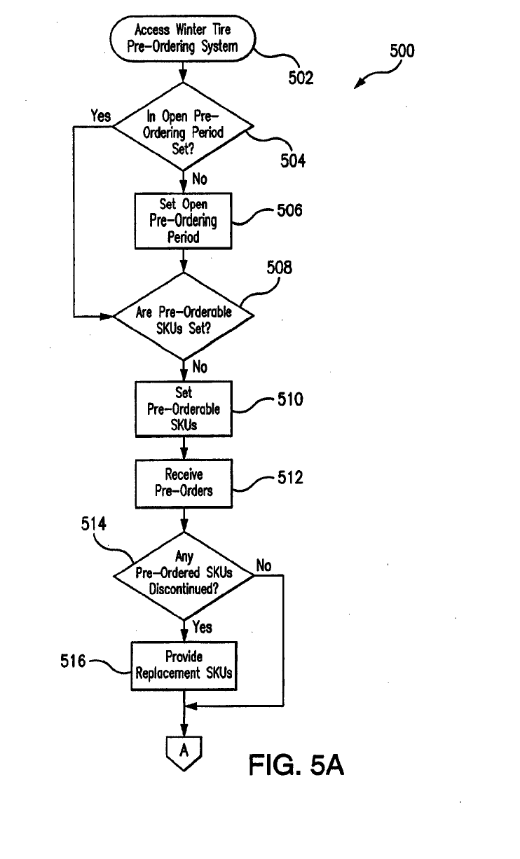

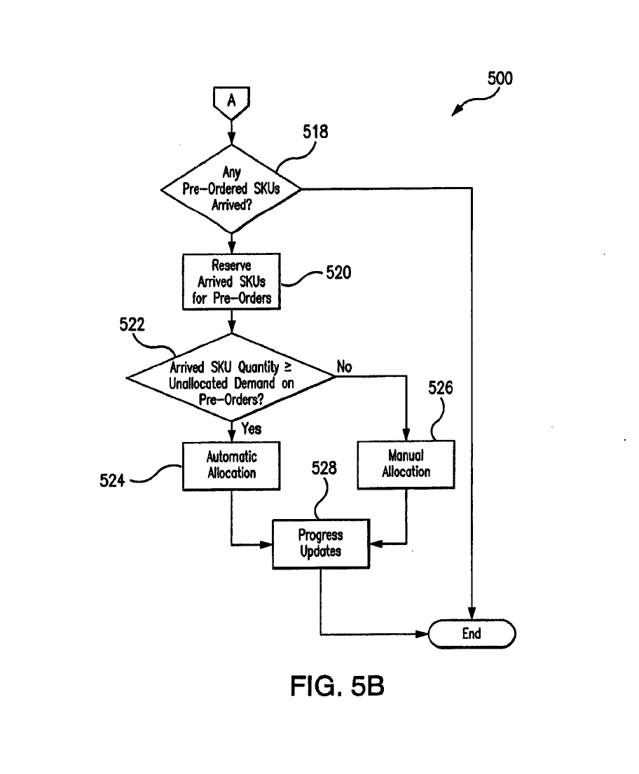

FIGS. 5A and 5B depict at 500 an example flow chart of a tire provider's interaction with a winter tire pre-ordering system. A tire provider may access a winter tire pre-ordering system at 502. The tire provider may check whether an open pre-ordering period is set at 504. If not, the tire provider may set the beginning and end date of the open pre-ordering period at 506. The tire provider may set such dates on an Original Equipment Manufacturer (OEM) or group basis. The OEM or group basis may apply to a unique Auto Manufacturer (Toyota, Ford, etc.). The tire provider may check whether pre-orderable SKUs are set at 508. If not, the tire provider may set a specific subset of winter tires or wheel assemblies as pre-orderable SKUs at 510. The pre-orderability of SKUs may be set on an OEM or group basis. The tire provider may choose only SKUs that are stocked as pre-orderable.

The tire provider may receive submitted pre-orders from the winter tire pre-ordering system at 512. The tire provider may check whether any pre-ordered SKUs are discontinued at 514. The tire provider may provide replacement SKUs for discontinued SKUs to the winter tire pre-ordering system at 516 and notify the dealers, so that dealers that are affected by discontinued SKUs may be given the ability to add replacement SKUs into their pre-orders.

All SKUs may be classified as SKUs for pre-orders or SKUs available to the general population and may be reserved in either of two pools, a pool for pre-ordered SKUs or a pool of SKUs available to the general population. These pools may be defined on a warehouse×SKU basis. The tire provider may move SKU quantity, en masse, between the two pools by warehouse, SKU, and quantity. A SKU with quantity in both pools may reside in the same physical bin.

As SKUs arrive at the warehouse, the tire provider may check whether the SKUs have been pre-ordered at 518. If the arrived SKUs have been pre-ordered, they may be reserved in the pool for pre-ordered SKUs at 520. SKUs reserved for pre-orders may need to be allocated on pre-orders, either manually or automatically, depending on whether arrived quantity for a SKU is greater than or equal to total unallocated demand on pre-orders as shown at 522. If arrived quantity for a SKU is greater than or equal to total unallocated demand on pre-orders, sufficient quantity of the SKU may be automatically allocated to all remaining demand on pre-orders at 524. Otherwise, the tire provider may manually allocate arrived SKU quantity to individual dealer pre-orders at 526. Reports of the current pre-order reserve pool and of the current demand on pre-orders may be generated for manual allocation. Progress updates of the status of fulfilling the pre-orders may be provided to the winter tire pre-ordering system at 528. The progress updates may include a delivery state selected from: order received, processing, sent to dealer, delivered, etc.

The tire provider may be able to access each dealer's pre-order in the winter tire pre-ordering system. The tire provider may have permission to add or delete SKUs, or modify status values of the SKUs in pre-orders at any time. Following the end of the open pre-ordering period, the status of pre-orders in the winter tire pre-ordering system may be updated with all changes initiated by the tire provider, namely quantity allocated, quantity available, and quantity shipped. These order status values may be updated regularly, but note that these updates do not necessarily need to be real time.

The changing of winter to off-season tires and vice-a-versa has created the need for tire storage services. A tire storage service system discussed herein facilitates and improves providing tire storage services to dealers and their customers. The tire storage service system encompasses the following business processes: providing web access to dealers for checking in/out of tires into tire storage services, performing tire storage services by tire storage service providers, billing to dealers via OEM or directly to dealers, and reporting to dealers.

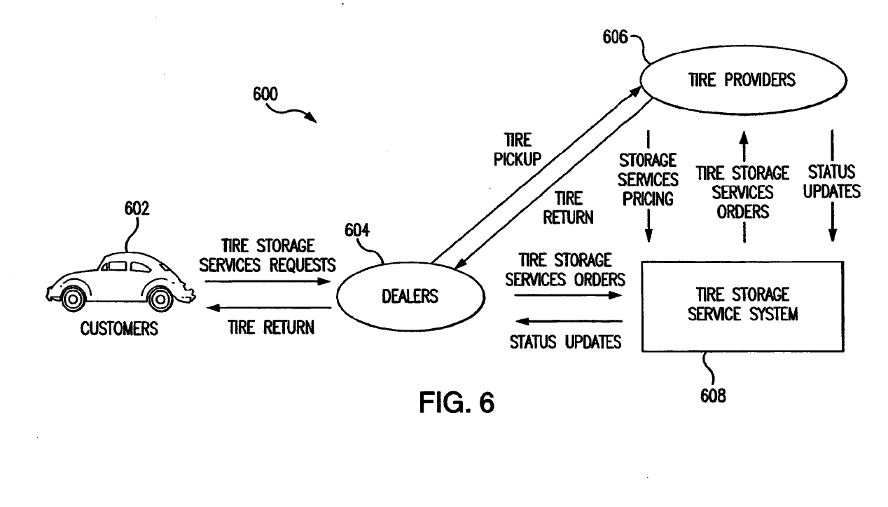

FIG. 6 depicts at 600 an example embodiment where customers 602, dealers 604 and tire storage service providers 606 interact with a tire storage service system 608. The dealers 604 may access the tire storage service system 608 to submit tire storage services orders to be fulfilled to satisfy tire storage services requests of the customers 602. The tire storage service providers 606 may interact with the tire storage service system 608 to receive the tire storage services orders submitted by the dealers 604. The tire storage service providers 606 may have tires picked up from the dealers 604, at a proper time or upon the request of the dealers 604, for performing the ordered tire storage services. Progress updates of the status of fulfilling the tire storage service orders may be provided to the tire storage service system 608 for updating the status of the tire storage service orders which may be tracked by the dealers 604. Upon completion of the ordered tire storage services, the tire storage service providers 606 may have the tires returned to the dealers 604, at a proper time or upon the request of the dealers 604. Once the dealers 604 receive the tires upon which tire storage services have been performed from the tire storage service providers 606, the tires may be returned to the customers 602, at a proper time or upon the request of the customers 602.

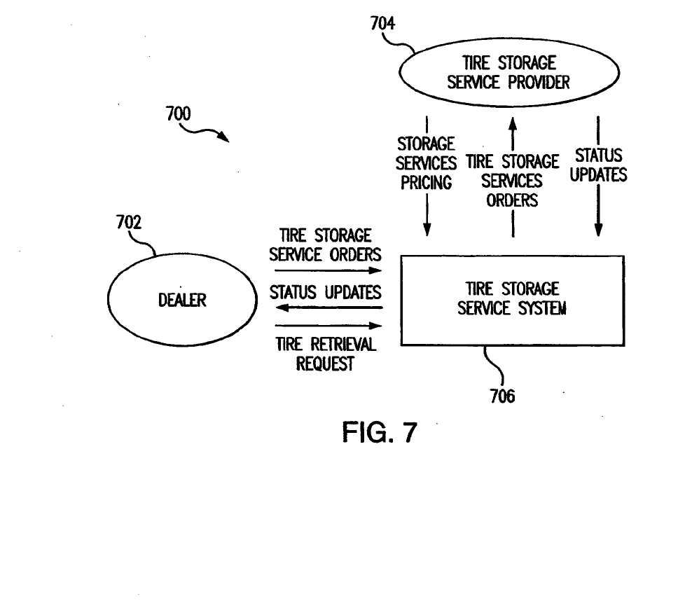

FIG. 7 depicts at 700 an example embodiment where a dealer 702 and a tire storage service provider 704 interact with a tire storage service system 706. Such interaction may be performed remotely via one or more networks or locally. A dealer 702 may access the tire storage system 706 via a web interface to transmit a tire storage service order to the tire storage system 706. Upon receiving such an order, the tire storage service system 706 alerts the tire storage service provider 704 to retrieve the tires identified by the tire storage service order from the dealer 702 and bring them to a storage facility.

A tire storage service order may include data in addition to data related to identifying the tires to be picked up for storage services. For example, the order may further detail a pickup time as well as upsell services that a customer wishing to have his tires stored has selected, often for additional cost. Such upsell services may include tire cleaning, inspection of the tires, balancing of the tires, as well as other services. The dealer 702 may be provided with pre-printed two-part labels with a serial number displayed in numeric and bar-code form. The dealer 702 may affix a label to a tire for storage services and a second label with a same serial number to paperwork.

The dealer 702 may track tire storage services data via an interface with the tire storage service system 706. Such tire storage data may include confirmation of safe storage of the tires, progress on any services being performed on the stored tires during their storage, availability of the stored tires for recall, as well as other data.

The dealer 702 may also provide a tire retrieval request to the tire storage service system 706. Such a request may identify a date that the dealer 702 wishes to have the stored tires delivered. Such a date may be selected by a customer for whom the dealer 702 is having the tires stored. Upon receipt of a tire retrieval request, the tire storage service system 706 may alert the tire storage service provider 704 to retrieve the stored tires from storage and have them delivered to the dealer 702.

The tire storage service provider 704 may also interact with the tire storage service system 706. The tire storage service provider 704 may be an entity that is associated with performing tire storage services, e.g., an employee/agent of a tire storer or a tire storer. The tire storage service provider 704 may provide storage options, upsell options, and pricing to the tire storage service system 706. The tire storage service provider 704 may receive and track tire storage services data such as the number of tires currently being stored, revenues from tire storage services, as well as other data. The tire storage service provider 704 may also update records in the tire storage service system 706. For example, upon completion of an upsell service, such as balancing a set of tires being stored, a tire store service provider 704 may input the completion of that upsell service into the tire storage service system 706 so that the records for the set of stored tires may be updated appropriately. The tire storage service provider 704 may provide additional information of the tires to the tire storage service system 706, e.g., tread depth is low, potential up-sell.

Tire storage services may be provided at the warehouses owned by the tire storage service provider 704. Storage facilities of the tire storage service provider 704 may not be in the same physical location as the shipping warehouse of the tire storage service provider 704.

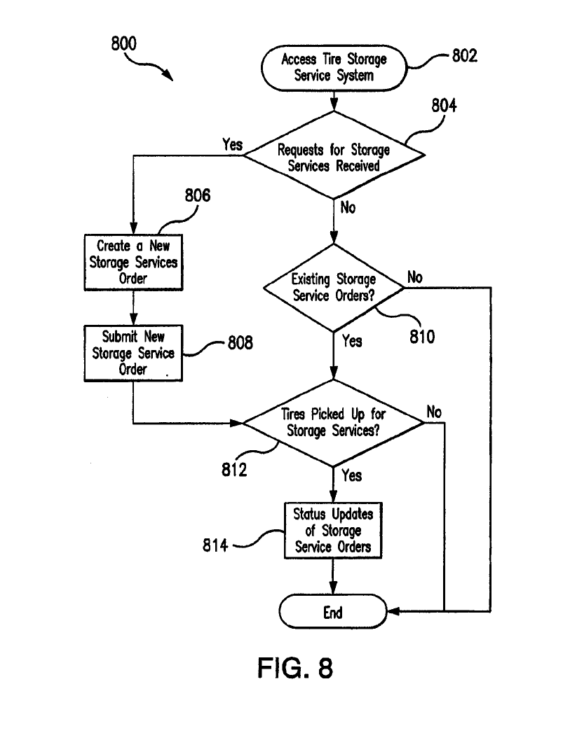

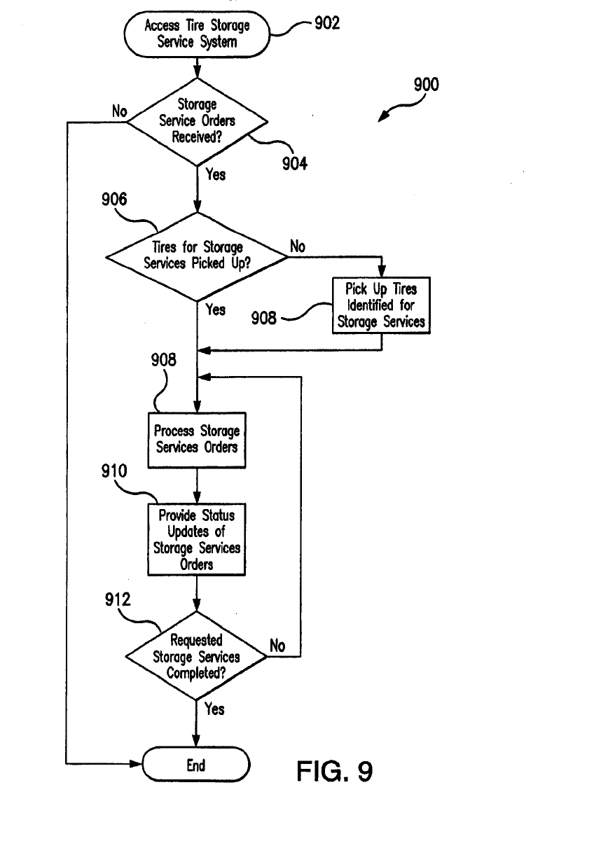

FIG. 8 depicts at 800 an example flow chart of a dealer's interaction with a tire storage service system. A dealer may access a tire storage service system at 802. If the dealer receives customer requests for tire storage services at 804, the dealer may create a new storage service order at 806 and submit the new storage service order at 808. If the dealer does not receive customer requests for tire storage services, the dealer may check whether there are any existing storage service orders in the tire storage service system at 810. For each submitted storage service order, the dealer may check in the tire storage service system whether tires have been picked up for storage services at 812. If a tire storage service provider has picked up the tires for storage services, the dealer may acquire status updates of the submitted storage service orders at 814.

Various data items may be input into the tire storage service system when a dealer places a tire storage service order, including serial number/or unique identifier to be passed to the creation of invoice, restrict quantity, identification of wheel type (chrome, alloy, steel etc), notes field for dealership to record existing damage to tires/wheels, position of tire (LF, RF, LR, RR), dealership services order, customer name, VIN, tire brand, DOT code, tire size, service level request. Service levels may include platinum (cleaning, inspection, balancing), gold (cleaning, inspection), silver (cleaning), or any other levels.

The tire storage service system may generate a report upon receiving a dealer's order. The report may comprise different data items, including customer name, serial (tag) number for each tire, dealership services order, dealership address, position of tire, tire brand, DOT code, tire size, service level request, packing/preparation instructions, and VIN.

A dealer may request return of stored tires by entering into the tire storage service system data items, including pre-printed label (serial) number for each tire, identification of wheel type (chrome, alloy, steel, etc), position of tire (LF, RF, LR, RR), dealership services order, customer name, and VIN.

FIG. 9 depicts at 900 an example flow chart of a tire storage service provider's interaction with a tire storage service system. A tire storage service provider may access a tire storage service system at 902. Then, the tire storage service provider may receive tire storage service orders at 904. Later, the tire storage service provider may check whether tires identified in the received tire storage service orders at 906. If the tires have not been picked up, the tire storage service provider may arrange pick-up of the tires at 908. Once the tires are picked up, the tire storage service provider may have the ordered storage services performed on the tires at 910. The tire storage service provider may have the ability to batch and process work related to services requested. Status updates of the received tire storage service orders may be provided to the tire storage service system at 912. Label may be generated for updating the status of the tires (e.g., 10=received, 20=cleaned, 30=inspected, 40=complete). The tire storage service provider may continue to perform the ordered storage services until the order has been fulfilled.

The concepts described herein may be useful in a variety of scenarios and environments. For example, the systems and methods described herein may be useful in Canada, where government regulations may require the use of snow tires, creating demand for pre-ordering and storage of off season tires. Such systems and methods may also be useful in the United States as well as other countries.

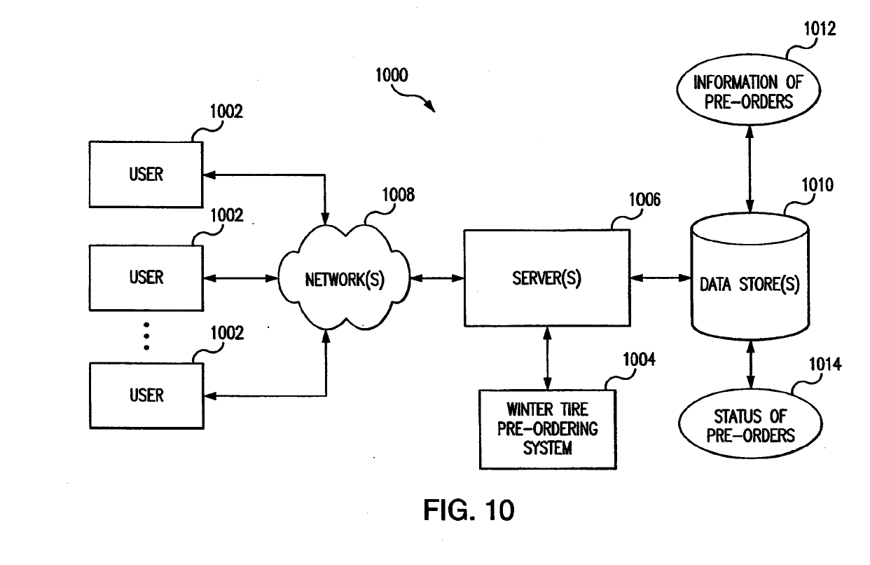

FIG. 10 depicts at 1000 a computer-implemented environment where users 1002 can interact with the winter tire pre-ordering system 1004 hosted on one or more servers 1006 through a network 1008. The winter tire pre-ordering system 1004 contains software operations. The users 1002 can interact with the winter tire pre-ordering system 1004 through a number of ways, such as over one or more networks 1008. One or more servers 1006 accessible through the network(s) 1008 can host the winter tire pre-ordering system 1004. The one or more data stores 1010 may contain information of pre-orders 1012 as well as status of pre-orders 1014.

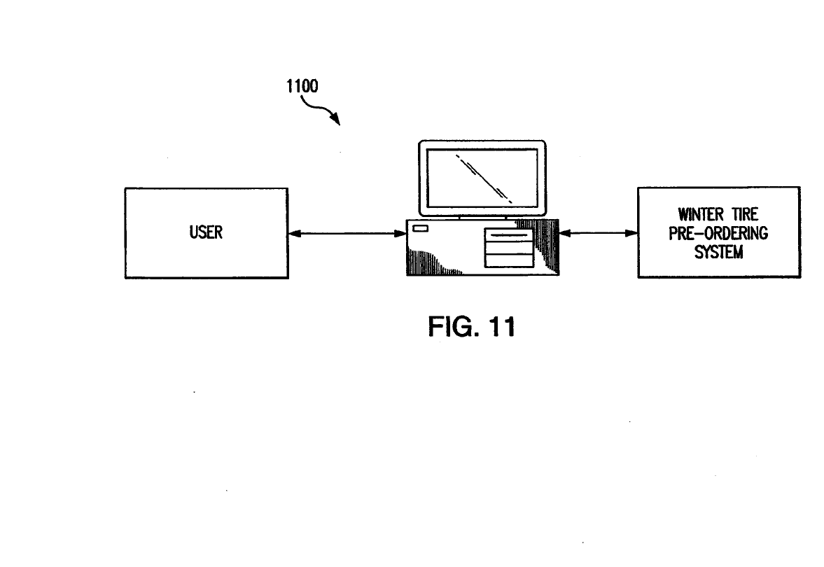

It may be understood that the winter tire pre-ordering system 1004 could also be provided on a stand-alone computer for access by a user, such as shown at 1100 in FIG. 11. The stand alone computer may be used to contain and/or implement the program instructions of system embodiments of the present invention. Optionally, program instructions may be stored on a computer readable storage medium such as a magnetic disk, optical disk, recordable memory device, flash memory, or other physical storage medium. Computer instructions may also be communicated via a communications signal, or a modulated carrier wave.

Though it is not illustrated in figures, a tire storage service system may be provided in a computer-implemented environment where users can interact with the tire storage service system hosted on one or more servers through a network, similar to FIG. 10. Also, a tire storage service system may be provided on a stand-alone computer for access by a user, similar to FIG. 11.

This written description uses examples to disclose the invention, including the best mode, and also to enable a person skilled in the art to make and use the invention. The patentable scope of the invention may include other examples. For example, a winter tire pre-ordering system and a tire storage service system may provide a link to an informational page on the pre-ordering process and the tire storage services ordering process, respectively. An option may be provided to not view the informational page again.

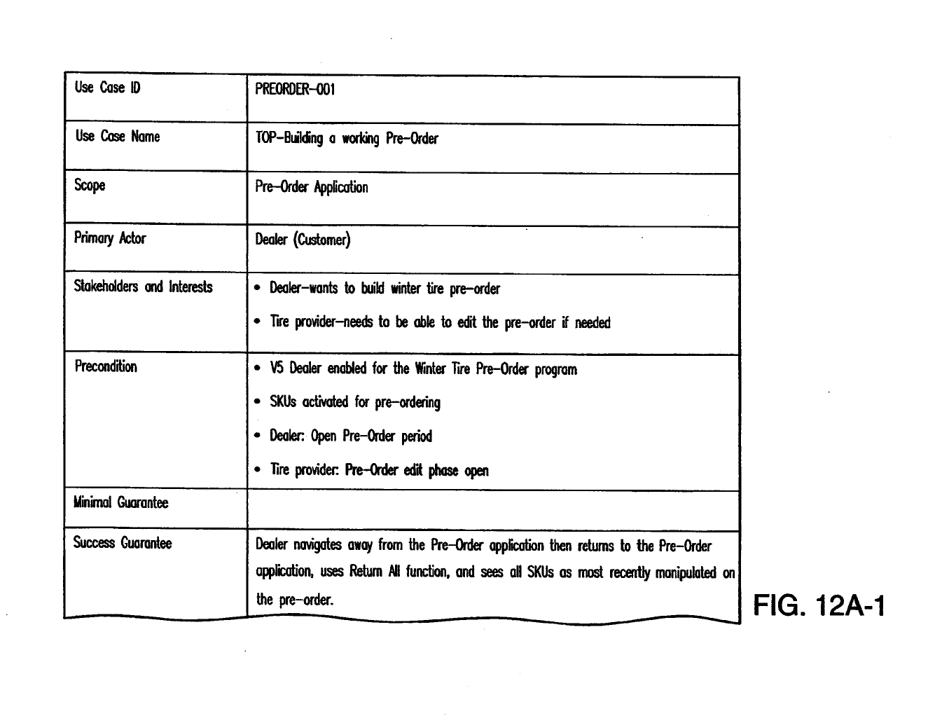

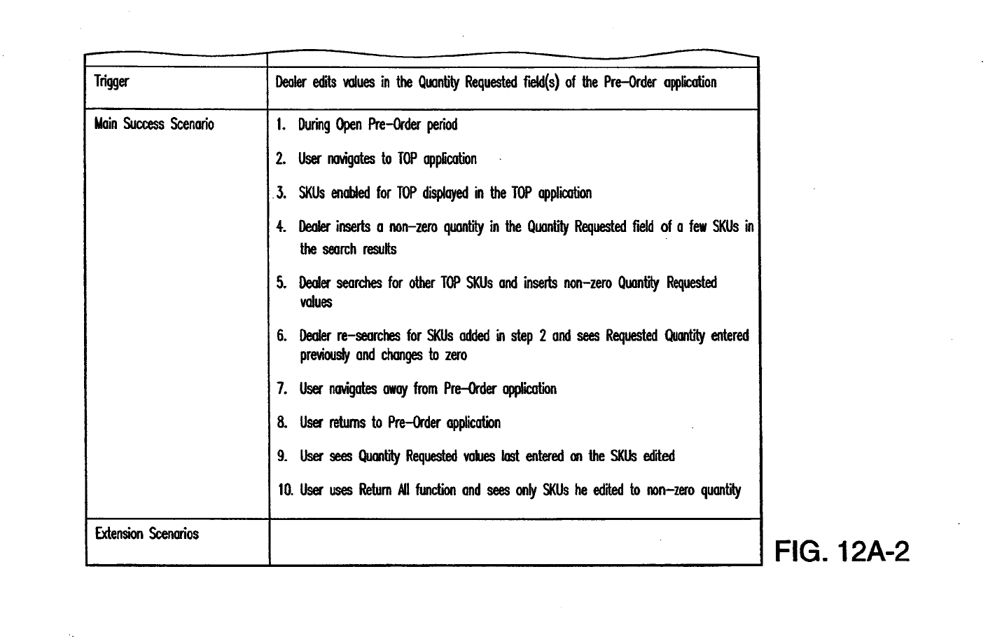

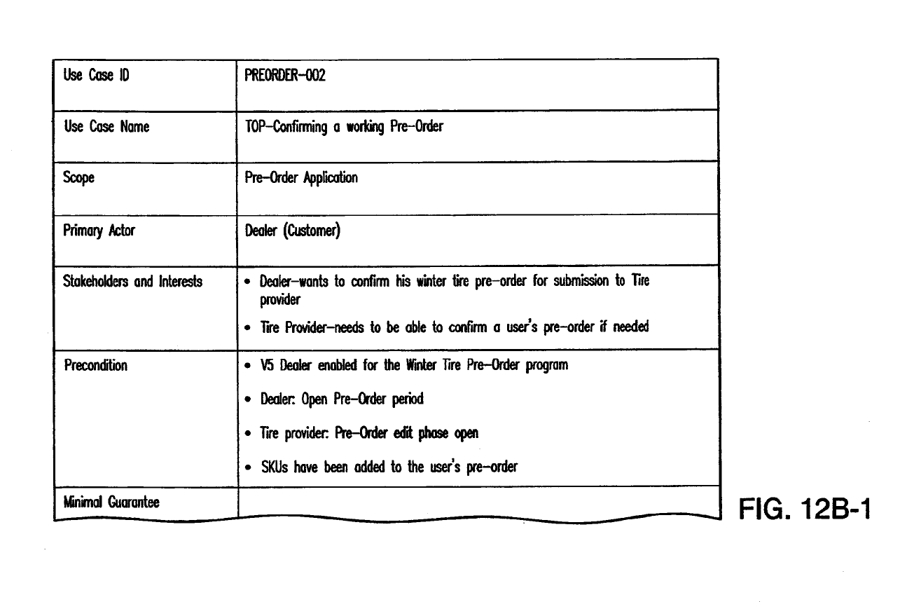

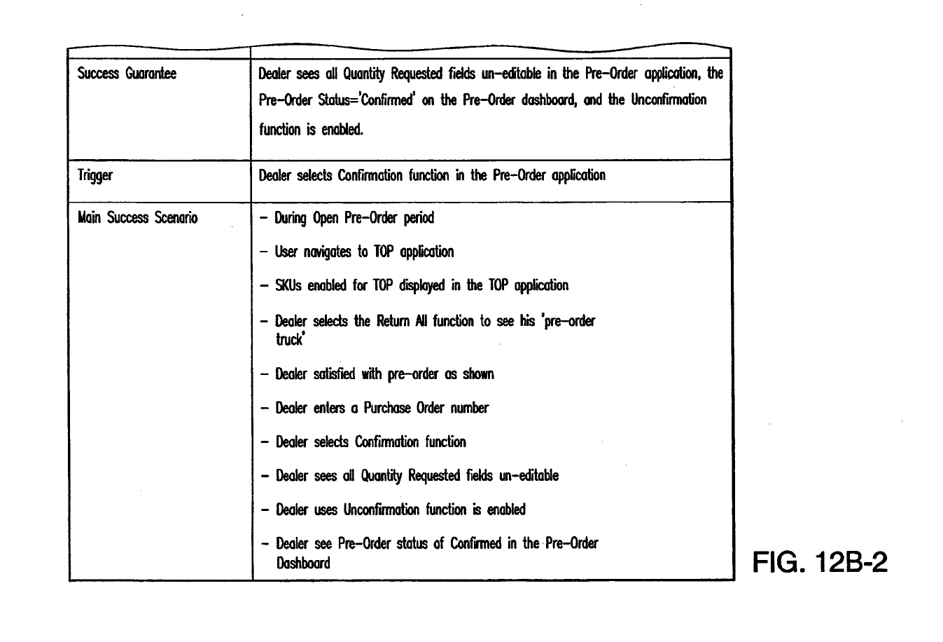

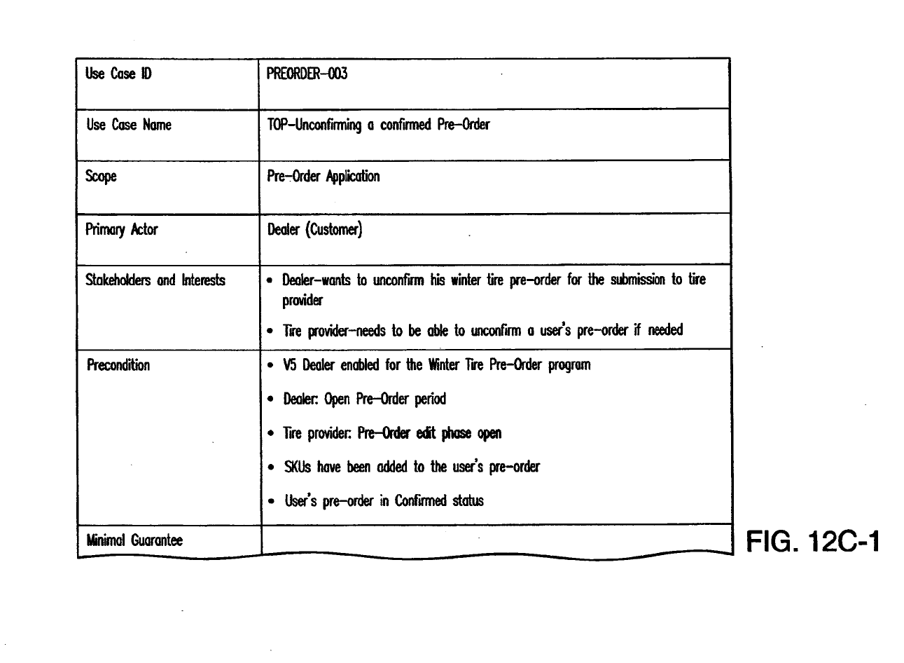

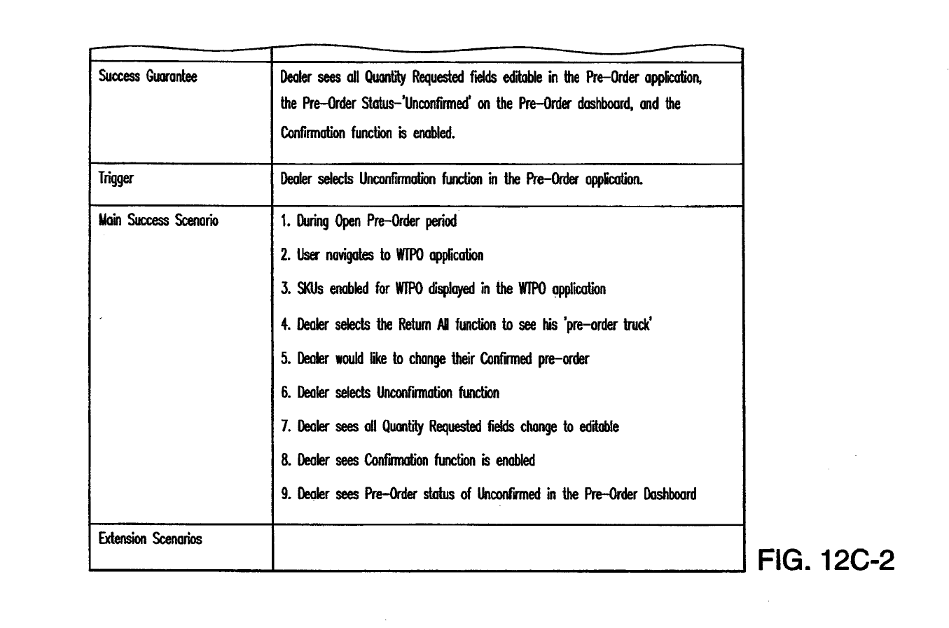

One example for a winter tire pre-ordering system may generate pre-order reports for a tire provider to act on winter tire pre-orders, for warehouse planning purposes, or for any other desirable purposes. The exemplary pre-order reports are shown in FIGS. 12A-12C.

Another example for a winter tire pre-ordering system (WTPO) described herein may include a Pre-Order application which may incorporate features as follows:

Save Button

All Winter Tires button
A press of All Winter Tires button will returns the complete list of tires enabled for WTPO. This button is active in all phases, including pre-open, open, allocation/shipping, closed, etc. If displaying all winter tires following the end of the open pre-order period, the prices displayed may be the pre-order price (the price of the SKU at the end of the open pre-order period).

Items I've Requested button
A press of Items I've Requested button will return only SKUs with Quantity Requested >0. This button is active in all phases.

Last Year's Order
A press of this button returns all SKUs with non-zero LYO/LYB. This button is active in all phases.

Confirm Order button
A press of this button may disable Quantity Requested controls. It may change order status to Confirmed. This button is active only during the open pre-order period.

Change Order (Unconfirm) button
A press of this button may re-enable the Quantity Requested controls. It may change order status to Unconfirmed. This button is active only during the open pre-order period.

Current Order Status display
It displays the current order status as Confirmed, Unconfirmed (default) or Order Placed.

Order column/Release Items button
This column/button may be displayed only after the end of the Open period. Users may be limited to requesting only up to the Quantity Available for a given SKU. If user enters quantity>available, an error message is displayed. A press on Release Items button throws up a dialog listing items and quantity to release along with the Purchase Order number and get user confirmation.

Pre-Order Form Column Layout

Pre-Open

| | | | | | | | | |
|---|---|---|---|---|---|---|---|---|
| LYO/ | SKU | Part# | Size | MFG | description | SR | EPS | Preorder |
| LYB | | | | | | | | Price |

Open

| | | | | | | | | | |
|---|---|---|---|---|---|---|---|---|---|
| Requested | LYO/LYB | SKU | Part# | Size | MFG | description | SR | EPS | Preorder Price |

Shipping

| | | | | | | | | | | | | |
|---|---|---|---|---|---|---|---|---|---|---|---|---|
| Requested | Allocated | Available | Released | Request | SKU | Part# | Size | MFG | description | SR | EPS | Preorder |
| | | | | Shipment | | | | | | | | Price |

Closed

| | | | | | | | | | | | |
|---|---|---|---|---|---|---|---|---|---|---|---|
| Requested | Allocated | Available | Released | SKU | Part# | Size | MFG | description | SR | EPS | Preorder Price |

Replacement Items for Obsolete SKUs (assuming Allocation or Shipping phases)
Order Status is changed to Unconfirmed. Confirm button (function) becomes active. Quantity Requested on obsolete SKU zeros out. All SKU Quantity Requested fields except replacement SKU may be disabled. Quantity Requested on replacement SKU is filled with Quantity Requested value formally on obsolete SKU. Obsolete/replacement SKUs as per mockups is displayed.

Another example for WTPO described herein may include a teaser that displays at start of the pre-open period, and is taken down at closed period. The teaser may show countdown to open period and end of open period, and may link to an informational page or the Pre-Order application.

Another example for WTPO described herein may include an Allocation Administration Application which may include the following features.
Show pre-order data for all users at once, organized as follows:
   By Dealer: For given dealer, show all SKUs ordered with the SKU details, such as SKU/Part Number, Quantity Requested, Quantity Allocated, Quantity Available.
   By SKU by Warehouse: For a given SKU, show all dealers with the input facing warehouse with SKU quantity requested greater than 0 and the SKU details, such as Quantity Requested, Quantity Available, Quantity Released, Quantity Allocated, Quantity Added.
Users may enter the quantity in the Unallocated inventory control of the application before beginning the allocation process. SKU quantity available for allocation may be the total committed and on-hand at the given location minus the current Total Available displayed in the application.
Once the Unallocated Inventory number is input, the users may then use the Fill All function or begin allocating to individual dealers against this quantity.
Updating Allocations for dealers. As dealer users increment the Allocated Quantity value for a dealer, the increase in the allocation (from the start up value) may be captured in the Quantity Added column for the dealer, and decremented from (or incremented to) the Unallocated inventory number. The user can not allocate beyond the value of Unallocated Inventory. If trying to allocate beyond, an error may be displayed, and the update ignored. Allocated Quantity entered for a dealer can not go above that dealer's Quantity Requested. If it does, an error message may be displayed and the allocation change ignored.
SAVE CHANGES Button
   A press of SAVE CHANGES may commit the allocation the user has entered. On this press, the Quantity Added value for each dealer may be added to the dealer's and total Quantity Available and redisplayed. Additionally, on SAVE CHANGES, the Total Allocated value may be changed.
CANCEL CHANGES Button
   A press of Cancel Changes may add all of the Quantity Added back to the Unallocated Inventory, decrement the Quantity Allocated to the dealers by their Quantity Added value, and zero out the Quantity Added.

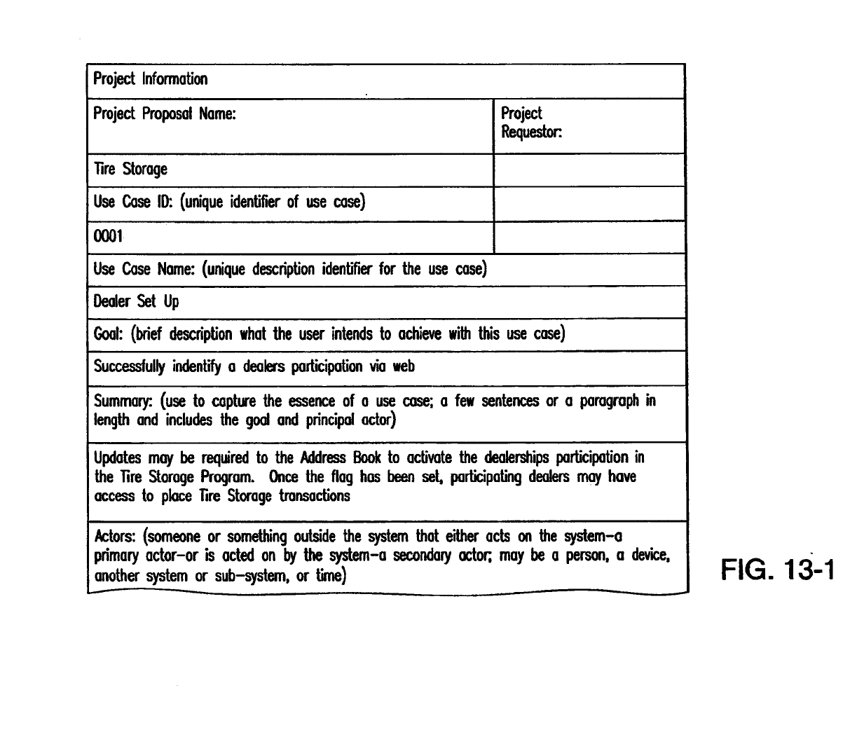

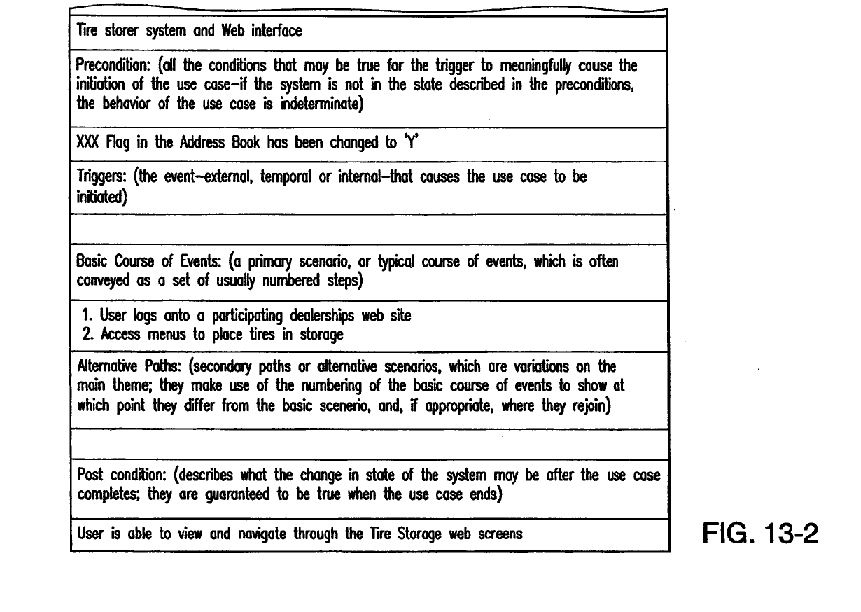

One example for a tire storage service system described herein may include a tire storage service program for dealers to participate. FIG. 13 depicts an example web screen for such a tire storage service program.

Another example of the tire storage service system may provide monthly billing based on the number of months tires stay in the facility where the tire storage service provider performs storage services. Different billing methods may be allowed, such as Original Equipment Manufacturer (OEM) billing and “off program” billing (billing directly to dealers). For example, each month, an OEM may be billed for a percentage of the total fee collected at the intake of tires. An OEM billing/invoice may contain various items, for matching in dealers' systems, including serial number(s) for tires in storage, original R.O. number, dealer number, customer name. The tire storage service system may allow for service billing upon completion of the storage services. The completion of storage services may trigger service billing to the OEM. A service billing/invoice may include different data items, such as serial numbers of services performed. The tire storage service system may allow for systematically matching of Zero dollar invoices/Service Orders.

Information entered into and generated from a winter tire pre-ordering system or a tire storage service system described herein, such as winter tire pre-orders, tire storage services orders, or various reports, may be exported into any desirable form importable by different software programs, such as Excel.

For example, the systems and methods may include data signals conveyed via networks (e.g., local area network, wide area network, interne, combinations thereof, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It may be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

It is claimed:

1. A processor-implemented method for preordering winter tires through a preordering system, said method comprising:
receiving, at the preordering system, information related to winter tires available for preordering from a tire provider;
providing the information related to winter tires available for preordering to a dealer;
receiving, from the dealer, information of preorders of winter tires;
providing the information of preorders of winter tires to the tire provider;
receiving, from the tire provider, updates on the status of the preorders of winter tires;
transmitting the updates on the status of the preorders of winter tires to the dealer;
wherein the steps of the method are performed using one or more processors.

2. The method of claim 1, wherein the information related to winter tires available for pre-ordering comprises one or more of the following: dates of open pre-ordering period, a listing of stock keeping units (SKUs) of pre-orderable winter tires and pricing information for the pre-orderable winter tires.

3. The method of claim 2, wherein winter tires are available for pre-ordering only during the open pre-ordering period.

4. The method of claim 2, wherein the tire provider sets open pre-ordering period and pre-orderable SKUs.

5. The method of claim 1, wherein only winter tires in stock are available for pre-ordering.

6. The method of claim 1, wherein the information of preorders of winter tires comprises a listing of quantities for SKUs for which the dealer preorders winter tires.

7. The method of claim 6, wherein the quantities for SKUs for which the dealer preorders winter tires are determined based on prior years' tire demands, tire demand information from customers, and anticipated winter severity.

8. The method of claim 6, wherein a replacement SKU is provided to the dealer if a preordered SKU is discontinued.

9. The method of claim 1, wherein the updates on the status of preorders of winter tires includes a delivery state selected from: order received, processing, sent to dealer, and delivered.

10. The method of claim 1, wherein the dealer un-confirms confirmed pre-orders before the dealer changes the pre-orders.

11. The method of claim 1, wherein the tire provider fulfills the pre-orders by automatically allocating available winter tires on pre-orders.

12. The method of claim 1, wherein the tire provider fulfills the pre-orders by manually allocating available winter tires on the pre-orders.

13. The method of claim 1, wherein the updates on the status of the preorders of winter tires comprise one or more of the following: progress updates on fulfilling the preorders, changes to available SKUs for pre-ordering, and pricing information for winter tires.

14. A processor-implemented method for tire storage services, said method comprising:
receiving, at a tire storage service system, a tire storage services order from a dealer;
providing the tire storage services order to a tire storage service provider;
receiving, at the tire storage service system, status updates of tire storage services performed by the tire storage service provider;
providing the status updates of tire storage services performed by the tire storage service provider to the dealer;
receiving, at the tire storage service system, a tire retrieval request from the dealer;
wherein the tire retrieval request comprises particular tires and a date of delivery;
providing the tire retrieval request to the tire storage service provider for delivery of the particular tires on the date of delivery;
wherein the steps of the method are performed using one or more processors.

15. The method of claim 14, wherein the tire storage services order comprises one or more of the following: data related to identifying tires to be picked up for storage services, pickup time, and upsell services.

16. The method of claim 15, wherein the upsell services include tire cleaning, tire inspection and balancing of tires.

17. The method of claim 14, wherein the status updates of tire storage services performed include one or more of the following: confirmation of pickup of tires, progress on services being performed, and availability for tire retrieval.

18. The method of claim 14, further comprising:
receiving, at the tire storage service system, tire storage services information from the tire storage service provider.

19. The method of claim 18, wherein the tire storage services information comprise one or more of the following: storage options, upsell options, and pricing information of services.

20. The method of claim 14, further comprising:
providing, from the tire storage service system, storage services data to the tire storage service provider.

21. The method of claim 20, wherein the storage services data comprises one or more of the following: the number of tires currently being stored for storage services, and revenues from tire storage services.

22. The method of claim 14, further comprising:
upon completion of a service by the tire storage service provider, updating service records at the tire storage service system.

23. A system for preordering winter tires, said system comprising:
one or more data processors;
a computer-readable storage medium encoded with instructions for commanding the one or more data processors to perform steps comprising:
receiving, at a preordering system, information related to winter tires available for preordering from a tire provider;
providing the information related to winter tires available for preordering to a dealer;
receiving, from the dealer, information of preorders of winter tires;
providing the information of preorders of winter tires to the tire provider;
receiving, from the tire provider, updates on the status of the preorders of winter tires;
transmitting the updates on the status of the preorders of winter tires to the dealer.

24. A system for tire storage services, said system comprising:
one or more data processors;
a computer-readable storage medium encoded with instructions for commanding the one or more data processors to perform steps comprising:
receiving, at a tire storage service system, a tire storage services order from a dealer;
providing the tire storage services order to a tire storage service provider;
receiving, at the tire storage service system, status updates of tire storage services performed by the tire storage service provider;
providing the status updates of tire storage services performed by the tire storage service provider to the dealer;
receiving, at the tire storage service system, a tire retrieval request from the dealer;
wherein the tire retrieval request comprises particular tires and a date of delivery;
providing the tire retrieval request to the tire storage service provider for delivery of the particular tires on the date of delivery.

25. A non-transitory computer-readable storage medium comprising programming instructions for preordering winter tires, the programming instructions adapted to cause a processing system to execute steps comprising:
receiving, at the preordering system, information related to winter tires available for preordering from a tire provider;
providing the information related to winter tires available for preordering to a dealer;
receiving, from the dealer, information of preorders of winter tires;
providing the information of preorders of winter tires to the tire provider;
receiving, from the tire provider, updates on the status of the preorders of winter tires;
transmitting the updates on the status of the preorders of winter tires to the dealer.

26. A non-transitory computer-readable storage medium comprising programming instructions for tire storage services, the programming instructions adapted to cause a processing system to execute steps comprising:
receiving, at a tire storage service system, a tire storage services order from a dealer;
providing the tire storage services order to a tire storage service provider;
receiving, at the tire storage service system, status updates of tire storage services performed by the tire storage service provider;
providing the status updates of tire storage services performed by the tire storage service provider to the dealer;
receiving, at the tire storage service system, a tire retrieval request from the dealer;
wherein the tire retrieval request comprises particular tires and a date of delivery;
providing the tire retrieval request to the tire storage service provider for delivery of the particular tires on the date of delivery.
